(19) United States
(12) Patent Application Publication
(10) Pub. No.: US 2026/0166963 A1
(43) Pub. Date: Jun. 18, 2026

(54) VEHICLE CLIMATE CONTROL SYSTEM AND METHOD TO REDUCE ICE BUILDUP

(71) Applicant: Ford Global Technologies, LLC, Dearborn, MI (US)

(72) Inventors: Alan Gutowski, Wixom, MI (US); Prathamesh Jadhav, Livonia, MI (US); David Alan Wong, Troy, MI (US)

(73) Assignee: Ford Global Technologies, LLC, Dearborn, MI (US)

(21) Appl. No.: 18/978,068

(22) Filed: Dec. 12, 2024

(51) Int. Cl. B60H 1/32

(52) U.S. Cl. CPC B60H 1/321; B60H 2001/3261

(57) ABSTRACT

A climate control system for a vehicle comprises of an air conditioner, a plurality of sensors, a plurality of timers, and a controller. The controller comprises a timing module, a storage module, and a processor. The timing module provides a plurality of timers and the storage module provides a plurality of calibrated thresholds and timer thresholds. The processor is configured to determine and execute an anti-icing strategy to predict and prevent the icing of an evaporator of the air conditioner. The processor executes the anti-icing strategy in accordance with various inputs provided by the plurality of sensors as compared to the plurality of calibrated thresholds. Additionally, the processor executes the anti-icing strategy in accordance with the amount of time one or more of the plurality of timers has been activated for in comparison with one or more of the plurality of timer thresholds.

### FIELD OF THE DISCLOSURE

The present disclosure generally relates to a vehicle climate control system, and more particularly to the prevention of ice buildup on an evaporator of an air conditioner of the vehicle climate control system through the execution of an anti-icing strategy.

### BACKGROUND OF THE DISCLOSURE

A vehicle may contain a climate control system to provide conditioned air to a user of the vehicle. The vehicle climate control system may employ an air conditioner comprising an evaporator for thermal transfer with air supplied to the interior of the vehicle and a condenser for thermal transfer with air ejected to the exterior of the vehicle. The evaporator and the condenser are coupled via a refrigerant line wherein a refrigerant is pumped through the refrigerant line by a compressor coupled with the refrigerant line. An expansion valve is interposed in the refrigerant line and reduces a pressure imposed on the refrigerant. The depressurized refrigerant enters the evaporator and absorbs heat from the air surrounding the evaporator. The depressurized refrigerant exits the evaporator into the refrigerant line and is subsequently repressurized by the compressor and urged into the condenser. Within the condenser, the pressurized refrigerant transfers heat to the surrounding air. The pressurized refrigerant then exits the condenser, reenters the refrigerant line, and is subsequently depressurized by the expansion valve. The refrigerant thus completes a heat transfer cycle wherein heat from air supplied to the interior of the vehicle is transferred to air exterior to the vehicle.

During operation of the air conditioner the evaporator chills to sub-freezing temperatures which may cause ice to buildup on the surface of the evaporator. Such buildup can reduce the efficiency of thermal absorption provided by the depressurized refrigerant within the evaporator. It would be desirable to provide for an enhanced system and method to prevent the buildup of ice on an evaporator.

### SUMMARY OF THE DISCLOSURE

According to a first aspect of the present disclosure, a climate control system for a vehicle is provided, wherein the climate control system comprises a compressor, an evaporator, a plurality of sensors, and a controller, in communication with the plurality of sensors and comprising at least one timer, the controller configured to execute an anti-icing strategy comprising the steps of monitoring the plurality of sensors, determining the likelihood of ice formation on the evaporator, adjusting the climate control system based on the determined likelihood of ice formation, activating one or more of the at least one timer in response to the adjustment of the climate control system, monitoring the at least one timer, and controlling the climate control system based on the at least one timer.

Embodiments of the first aspect of the present disclosure can include any one or a combination of the following features:
At least one of the plurality of sensors comprises a duct air temperature sensor.
At least one of the plurality of sensors comprises an ambient air temperature sensor.
The controller determines the likelihood of ice formation on the evaporator by comparing a duct discharge air temperature target to a duct discharge air temperature target threshold.
The controller determines the likelihood of ice formation on the evaporator by comparing inputs provided to the controller by the plurality of sensors to a plurality of calibrated thresholds.
The controller determines the likelihood of ice formation on the evaporator by comparing the time the at least one timer has been activated for to a plurality of timer thresholds.
The controller adjusts the climate control system based on the determined likelihood of ice formation by adjusting an evaporator target temperature with a calibrated value.
The controller adjusts the climate control system based on the determined likelihood of ice formation by adjusting an evaporator target temperature with a calibrated value, wherein the controller determines that there is a likelihood of ice formation when each of the plurality of sensors detects an input that reaches a calibrated threshold.
The controller adjusts the climate control system based on the determined likelihood of ice formation by deactivating the compressor.
The controller adjusts the climate control system based on the determined likelihood of ice formation by deactivating the compressor, wherein the controller determines that there is a likelihood of ice formation when one or more of the plurality of sensors detect an input that reaches a calibrated threshold and when the at least one timer has been activated for a time exceeding a timer threshold.
The controller adjusts the climate control system based on the determined likelihood of ice formation by reactivating the compressor, wherein the controller determines that there is not a likelihood of ice formation when one or more of the plurality of sensors detects an input that reaches the calibrated threshold, wherein the calibrated threshold is a duct air temperature exit condition threshold.
The controller adjusts the climate control system based on the determined likelihood of ice formation by reactivating the compressor, wherein the controller determines that there is not a likelihood of ice formation when the at least one timer has been activated for a time equal to or exceeding the timer threshold, wherein the timer threshold is a compressor reactivation timer threshold.
The controller determines that there is a likelihood of ice formation when each of the plurality of sensors detects an input that reaches a calibrated threshold and the compressor has an active status.

According to a second aspect of the present disclosure, a method for controlling a vehicle climate control system is provided comprising the steps of activating a compressor of the vehicle climate control system; sensing ambient air temperature with a first temperature sensor; sensing air duct temperature with a second temperature sensor; monitoring, with a controller, the sensed ambient air temperature and the duct air temperature; determining the likelihood of ice formation on the evaporator; adjusting, with the controller, the vehicle climate control system based on the determined likelihood of ice formation; activating at least one timer in response to the adjusting of the vehicle climate control system with the controller; and controlling the vehicle climate control system based on the least one timer.

Embodiments of the second aspect of the present disclosure can include any one or a combination of the following features:
The second temperature sensor may comprise of a duct air temperature sensor.
The controller determines the likelihood of ice formation on the evaporator by comparing a duct discharge air temperature target to a duct discharge air temperature target threshold.
The controller determines the likelihood of ice formation on the evaporator by comparing inputs provided to the controller by the plurality of sensors to a plurality of calibrated thresholds.
The controller adjusts the climate control system based on the determined likelihood of ice formation by adjusting an evaporator target of an evaporator with a calibrated value.
The controller adjusts the vehicle climate control system based on the determined likelihood of ice formation by deactivating the compressor, wherein the controller determines that there is a likelihood of ice formation when one or more of the plurality of sensors detect an input that reaches a calibrated threshold and when the at least one timer has been activated for a time exceeding a timer threshold.
The controller adjusts the vehicle climate control system based on the determined likelihood of ice formation by reactivating the compressor, wherein the controller determines that there is not a likelihood of ice formation when the second sensor detects an input that is greater than a calibrated threshold, wherein the calibrated threshold is a duct air temperature exit condition threshold.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a schematic of a vehicle provided with a climate control system.

FIG. 2 is a schematic of a portion of the vehicle climate control system.

FIG. 3 is a schematic of a portion of the vehicle climate control system provided with a plurality of sensors.

FIG. 4 is a diagram of the control system for the vehicle climate control system.

FIG. 5 is a diagram of the controller of the vehicle climate control system.

FIG. 6A-6B is a flow chart showing the process undertaken by a processor of the controller to determine and execute a first embodiment of an anti-icing strategy.

FIG. 7A-7B is a flow chart showing the process undertaken by a processor of the controller to determine and execute a second embodiment of the anti-icing strategy.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

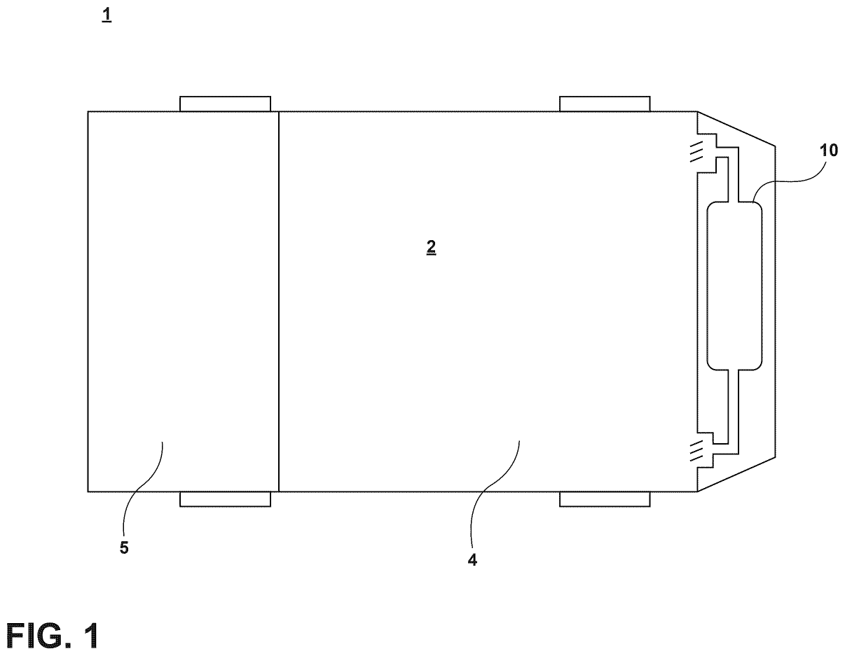

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a vehicle climate control system. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIG. 1, a vehicle 1 is illustrated. The vehicle 1 may be a manually operated vehicle, a fully autonomous vehicle, or a partially autonomous vehicle. The vehicle 1 may be powered by an internal combustion engine, a fully electric engine, or may be provided with a hybrid engine utilizing both internal combustion and electrical power. The vehicle 1 is provided with an interior 2 comprising a passenger compartment 4 and a cargo compartment 5. A vehicle climate control system 10 is provided to the vehicle 1 to condition air supplied to the interior of the vehicle 2. The vehicle climate control system 10 may increase a temperature of air supplied to the interior of the vehicle 2, decrease a temperature of air supplied to the interior of the vehicle 2, increase a quantity of water vapor within the air supplied to the interior 2 of the vehicle 1, and decrease a quantity of water vapor within the air supplied to the interior 2 of the vehicle 1.

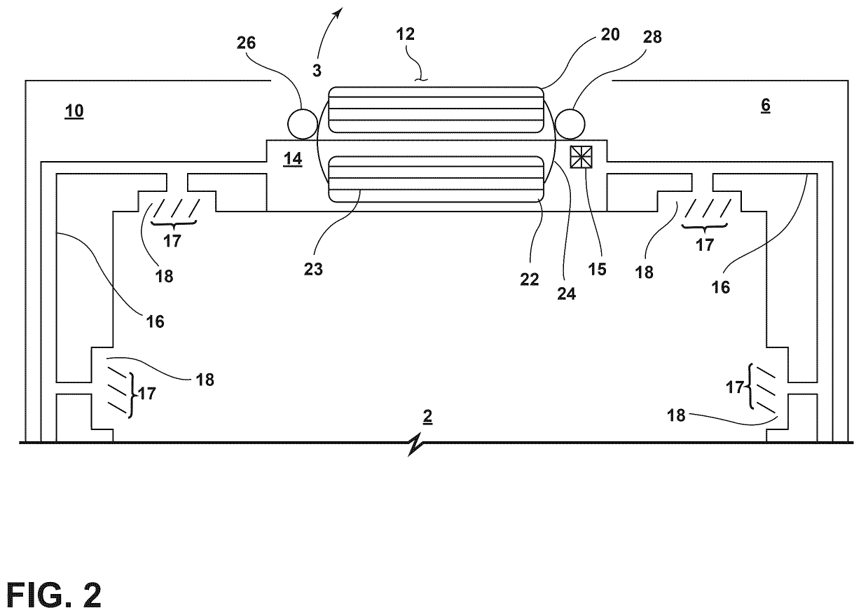

Referring now to FIG. 2, a schematic of the vehicle climate control system 10 is shown. The vehicle climate control system 10 may comprise of an air conditioner 12, a plenum 14, a plurality of ducts 16, and a plurality of vent registers 18. The air conditioner 12 is configured to effectuate a transfer of heat to air exterior to the vehicle 3. The air conditioner 12 may comprise of an condenser 20 and an evaporator 22 interlinked by a refrigerant line 24. The condenser 20 may be positioned such that it is in thermal communication with the air exterior to the vehicle 3. The evaporator 22 may be positioned such that it is in thermal communication with the air within the interior 2 of the vehicle 1. Both the condenser 20 and the evaporator 22 may comprise of a plurality of channels 23 which provide a surface area to effectively transfer heat out of the condenser 20 and to transfer heat into the evaporator 22. The condenser 20, the evaporator 22, and the refrigerant line 24 form a refrigerant loop through which a refrigerant is cycled. The refrigerant is configured to undergo phase changes as the refrigerant is cycled through the refrigerant loop. A compressor 26 may be interposed within the refrigerant line 24 to increase a pressure applied to the refrigerant and urge the refrigerant along the refrigerant loop. An expansion valve 28 may be interposed within the refrigerant line 24 to decrease a pressure applied to the refrigerant.

When cooling the interior of the vehicle 2, a refrigerant flows through the refrigerant line 24 and passes into the compressor 26 wherein the refrigerant is compressed to a pressurized state resulting in the refrigerant having a higher temperature. The pressurized refrigerant then enters the condenser 20, wherein the pressurized refrigerant transfers heat across the surface area of the plurality of channels 23 provided by the condenser 20. Heat is then transferred from the pressurized refrigerant to the air surrounding the condenser 20, resulting in an increase in temperature of the air surrounding the condenser 20. The refrigerant then exits the condenser 20 and again enters the refrigerant line 24 continuing to the expansion valve 28. The expansion valve 28 effectuates a rapid depressurization of the refrigerant resulting in at least a portion of the refrigerant undergoing an evaporative phase change. The rapid depressurization and subsequent evaporation results in a decrease in the temperature of the refrigerant. In the depressurized state, the refrigerant then enters the evaporator 22, wherein the depressurized refrigerant absorbs heat across the surface area of the plurality of channels 23 provided by the evaporator 22. Heat is transferred from the air surrounding the evaporator 22 to the refrigerant, resulting in a decrease in the temperature of the air surrounding the evaporator 22. The refrigerant then exits the evaporator 22 into the refrigerant line 24 where it again enters into the compressor 26 to repeat the heat transfer cycle.

Referring still to FIG. 2, the plenum 14, the plurality of ducts 16, and the plurality of vent registers 18 are provided to supply the cooled air that has exchanged heat with the evaporator 22 to the interior of the vehicle 2. The plenum 14 is configured to receive the air cooled by the air conditioner 12 for distribution to the rest of the vehicle climate control system 10. The plurality of ducts 16 extend from the plenum 14 through the interior structure 6 of the vehicle to each of the plurality of vent registers 18. The plurality of vent registers 18 are configured to then discharge the cooled air to the interior of the vehicle 2. Each of the plurality of vent registers 18 may be fitted with a user operable air flow control means 17 configured to allow a user within the interior of the vehicle 2 to adjust the flowrate of the cooled air flowing from each of the plurality of vent registers 18.

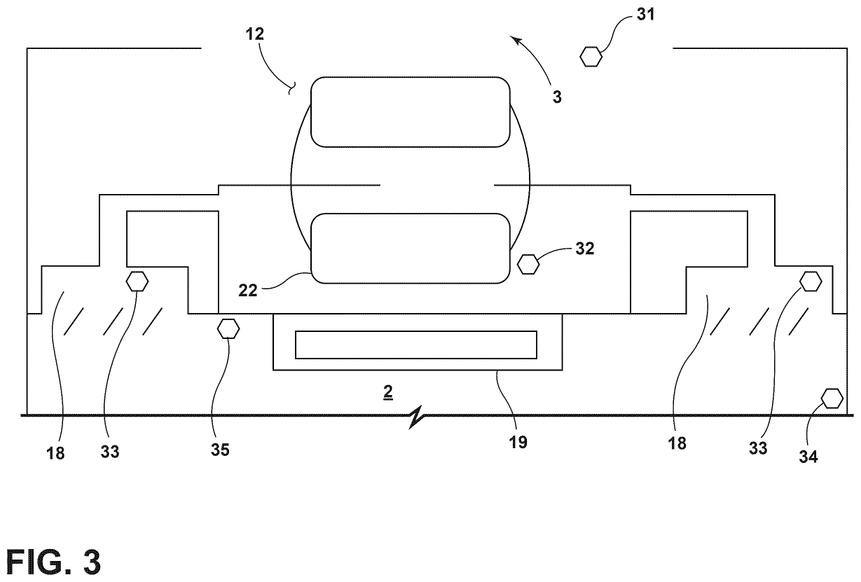

Referring now to FIG. 3, the climate control system 10 further includes a user interface 19 that allows the user of the vehicle 1 to control the climate control system 10. The user interface 19 is configured to receive inputs from the user of the vehicle 1. Specifically, the user interface 19 may be configured to allow a user to at least indirectly determine a duct discharge air temperature (DAT) target of the climate control system 10. The DAT target is the calculated temperature of air supplied by the plurality of vent registers 18 to the interior of the vehicle 2, as determined by a processor 46 of the climate control system to achieve a temperature set point of the interior of the vehicle 2 that is set by the user. The user interface 19 may comprise of a multi-function display or a human machine interface.

Referring still to FIG. 3, a plurality of sensors 30 are provided to monitor a plurality of sensed attributes that characterize the vehicle climate control system 10. The plurality of sensed attributes may include a temperature of the air exterior to the vehicle 3; a temperature of the evaporator 22; a temperature of air discharged by one or more of the plurality of vent registers 18; a water vapor content of air within the interior of the vehicle 2; and a quantity of particulate matter within the interior of the vehicle 2. The plurality of sensors 30 may comprise an ambient air temperature sensor 31; an evaporator core temperature sensor 32; a duct discharge air temperature (DAT) sensor 33; an interior humidity sensor 34; and an interior particulate matter (PM) sensor 35.

The ambient air temperature sensor 31 is configured to detect the temperature of the air exterior to the vehicle 3. The ambient air temperature sensor 31 may be positioned within the exterior grille of the vehicle or may be coupled with one of the side mirrors of the vehicle, for example.

The evaporator temperature sensor 32 is configured to detect the temperature of the evaporator 22. The evaporator temperature sensor 32 may be positioned proximal to the evaporator 22 and may comprise a thermistor configured to change in electrical resistance as the temperature of the thermistor is modified. Additionally, there may be a plurality of evaporator temperature sensors 32 positioned at unique portions of the evaporator 22 to monitor the temperature of the different portions of the evaporator 22.

The DAT sensor 33 is configured to detect the temperature of the air supplied to the interior of the vehicle 2 through the plurality of ducts 16. There may be a plurality of DAT sensors 33, wherein each of the plurality of DAT sensors 33 is provided at each of the plurality of vent registers 18 to monitor the temperature of air supplied by each of the plurality of vent registers 18. Additionally, there may be a plurality of DAT sensors 33 wherein more than one DAT sensor 33 is positioned at a single vent register of the plurality of vent registers 18 to monitor the temperature of air supplied by the single vent register of the plurality of vent registers 18.

The interior humidity sensor 34 is configured to detect the quantity of water vapor present in the air contained within the interior of the vehicle 2. There may be a plurality of interior humidity sensors 34 to monitor the quantity of water present in the air contained within the interior of the vehicle 2 at different locations within the interior of the vehicle 2. The humidity sensor 34 may comprise of a capacitive sensor, for example, configured to monitor changes in a voltage present between two electrodes.

The interior particulate matter sensor 35 is configured to detect the quantity of particulate matter suspended within the air contained within the interior of the vehicle 2. There may be a plurality of interior particulate matter sensors 35 to monitor the quantity of particulate matter suspended within the air contained within the interior of the vehicle 2 at different locations within the interior of the vehicle 2. The interior particulate matter sensor 35 may utilize optical sensing to detect the quantity of particulate matter or may be configured to utilize resistance measurements to detect particulate matter deposited on an electrode structure of the interior particulate matter sensor 35.

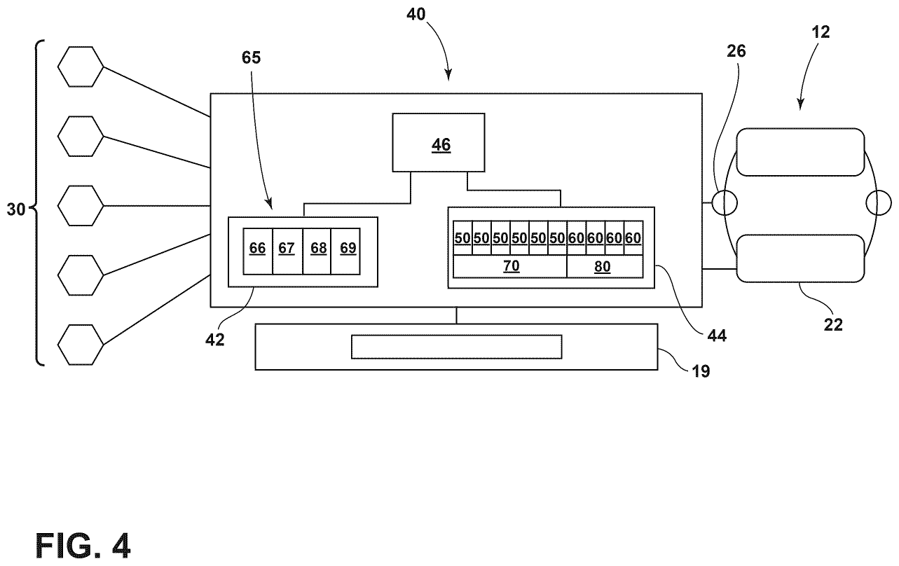

Referring now to FIG. 4, the vehicle climate control system 10 may further include a controller 40 configured to control the operation of the climate control system 10. The controller 40 is in electronic communication with each of the plurality of sensors 30, such that the controller 40 receives from each of the plurality of sensors 30 inputs corresponding to the plurality of sensed attributes that characterize the climate control system 10. Next, the controller 40 is in electronic communication with the air conditioner 12 and is configured to modify the operations of the air conditioner 12. Additionally, the controller 40 is in electronic communication with a user interface 19, such that the controller 40 receives commands generated by the user interface 19 in response to a user input to the user interface 19. Specifically, the controller 40 is configured to receive from the user interface 19 the temperature set point for the interior of the vehicle 2 and calculate the DAT target.

Referring still to FIG. 4, the controller 40 includes a timing module 42, a storage module 44, and the processor 46. The controller 40 may be a controller dedicated to HVAC control or may be a shared controller capable of performing additional control functions. The processor 46 may include a microprocessor, for example, or may be configured with other analog and/or digital circuity. The storage module 44 of the controller 40 is configured to store a plurality of calibrated thresholds 50; a plurality of timer thresholds 60; a calibrated value 70; and a strategy history 80. The timing module 42 provides a plurality of timers 65. The processor 46 of the controller 40 is configured to monitor the plurality of sensors 30 and the plurality of timers 65. Additionally, the processor 46 of the controller 40 is configured to monitor an operational status of the compressor 26 along with the DAT target set by the user through the user interface 19. Next, the processor 46 is configured to determine and execute an anti-icing strategy 98, 99 in accordance with the inputs provided by the plurality of sensors 30 as compared with one or more of the plurality of calibrated thresholds 50. Additionally, the processor 46 is configured to determine and execute the anti-icing strategy 98,99 in accordance with the amount of time one or more of the plurality of timers 65 has been activated for in comparison with one or more of the plurality of timer thresholds 60. Also, the processor 46 is configured to determine and execute the anti-icing strategy 98,99 in accordance with the operational status of the compressor 26; the strategy history 80; and the DAT target. The anti-icing strategy 98,99 is a predictive method, wherein the processor 46 is configured to make predictions and determine whether adjustments to the air conditioner 12 are necessary to prevent the formation of ice on the evaporator 22. In operation, the anti-icing strategy 98,99 modifies the air conditioner 12 through a plurality of adjustments made to the air conditioner 12 by the processor 46, wherein the plurality of adjustments function to prevent the evaporator 22 of the air conditioner 12 from icing over. Specifically, the plurality of adjustments comprises modifying an evaporator temperature target by the calibrated value 70 to warm the evaporator 22, deactivating the compressor 26; and activating the compressor 26.

Referring still to FIG. 4, the timing module 42 provides a plurality of timers 65, wherein the plurality of timers 65 comprises a vehicle timer 66; a compressor deactivation timer 67; a compressor reactivation timer 68; and an exit timer 69. The processor 46 is configured to activate at least one of the plurality of timers 65 in response to the processor 46 adjusting the climate control system 10.

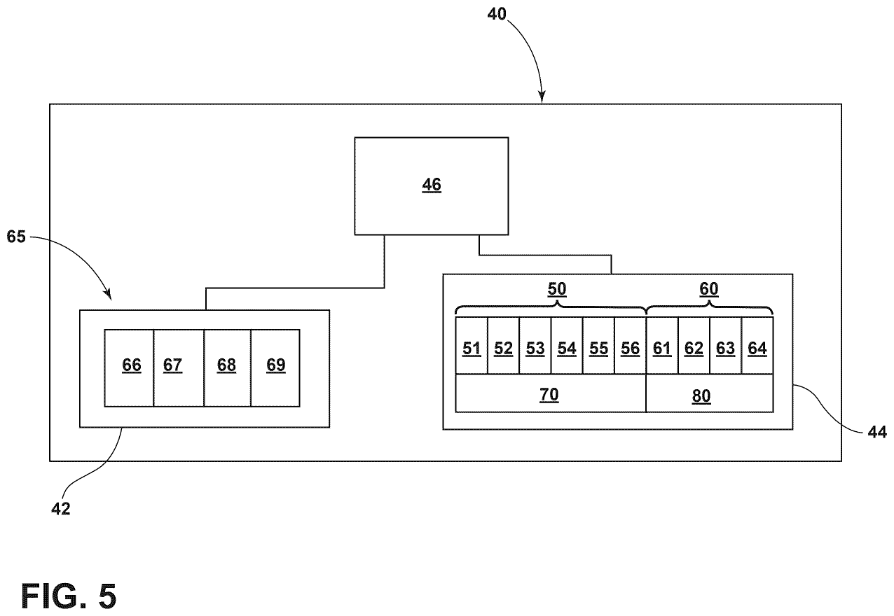

FIG. 5 illustrates the storage module 44 wherein the storage module 44 provides the plurality of calibrated thresholds 50. Each of the plurality of calibrated thresholds 50 is a predictive numerical value representing one of the plurality of attributes. Specifically, each of the plurality of calibrated thresholds 50 is the value of one of the plurality of attributes at which there is a statistical likelihood that the evaporator 22 will ice over if the value of the represented attribute reaches a value greater than or less than one of the plurality of calibrated thresholds 50 for a period of time. The plurality of calibrated thresholds 50 may function to partially define the operating conditions at which the air conditioner 12 can operate before there is a high possibility that the evaporator 22 will ice over. Each of the plurality of calibrated thresholds 50 is stored within the storage module 44 of the controller 40 and may be updated through an over-the-air system. The processor 46 is configured to access each of the plurality of calibrated thresholds 50 when determining and executing the anti-icing strategy 98,99. In operation, the processor 46 may be configured to adjust the climate control system 10 in response to a detection by the processor 46 that at least one of the plurality of sensors 30 has provided an input that was greater or less than or equal to one of the plurality of calibrated thresholds 50. Additionally, the processor 46 may be configured to adjust the climate control system 10 in response to a detection by the processor 46 that each of the plurality of sensors 30 has provided an input that is greater, less than, or equal to one of the plurality of calibrated thresholds 50. The plurality of calibrated thresholds 50 may include a DAT entry condition threshold 51; a DAT compressor function threshold 52; DAT exit condition threshold 53; an ambient condition threshold 54, an interior humidity threshold 55; and an interior particulate matter threshold 56.

The DAT entry condition threshold 51 is the DAT at which there is a statistical likelihood that the evaporator 22 will ice over if the air conditioner 12 continues operation without adjustment. The DAT entry condition threshold 51 may represent a DAT that is near the freezing point of water.

The DAT compressor function threshold 52 is the DAT at which there is a statistical likelihood that the evaporator 22 will ice over if the air conditioner 12 continues operation without adjustment, wherein the DAT represented by the DAT compressor function threshold 52 is a higher temperature than the DAT represented by the DAT entry condition threshold 51.

The DAT exit condition threshold 53 is the DAT at which there is a statistical likelihood that the evaporator 22 will ice over if the air conditioner 12 continues operation without adjustment, wherein the DAT represented by the DAT exit condition threshold 53 is a higher temperature than the DAT represented by the DAT compressor function threshold 52.

The ambient threshold 54 is the temperature of air exterior to the vehicle 3 at which there is a statistical likelihood that the evaporator 22 will ice over if the air conditioner 12 continues operation without adjustment.

The interior humidity threshold 55 is the quantity of water vapor within the interior of the vehicle 2 at which there is a statistical likelihood that the evaporator 22 will ice over if the air conditioner 12 continues operation without adjustment.

The interior particulate matter threshold 56 is the quantity of particulate matter suspended within the air of the interior of the vehicle 2 at which there is a statistical likelihood that the evaporator 22 will ice over if the air conditioner 12 continues operation without adjustment.

Still referring to FIG. 5, the storage module 44 stores a calibrated value 70. The calibrated value 70 is a temperature value by which the processor 46 will adjust an evaporator target temperature with to warm the evaporator 22 during the execution of the anti-icing strategy 98. The evaporator target temperature is the temperature of the evaporator 22 at which the evaporator 22 can provide air at the temperature set by the user through the DAT target to the interior of the vehicle 2. The calibrated value 70 may represent the smallest increase in the evaporator target temperature that will result in the prevention of ice forming on the evaporator 22 or the removal of ice formed on the evaporator 22. This allows for the evaporator target temperature to be adjusted with the calibrated value 70, preventing the evaporator 22 from icing over while, while still allowing the evaporator 22 to provide air of a user desired temperature to the interior of the vehicle 2. The calibrated value 70 may be loaded to the storage module 44 prior to use by the vehicle user. Additionally, the calibrated value 70 may be updated through an over-the-air system.

FIG. 5 additionally illustrates the storage module 44 wherein the storage module 44 provides the plurality of timer thresholds 60. Each of the plurality of timer thresholds 60 is a predictive length of time associated with at least one of the plurality of timers 65. Specifically, each of the plurality of timer thresholds 60 is the length of time at which there is a statistical likelihood that the evaporator 22 will ice over if the associated timer of the plurality of timers 65 has been activated for a length of time either greater than, less than or equal to one of the plurality of timer thresholds 60. The processor 46 is configured to adjust the climate control system 10 in response to a detection by the processor 46 that at least one of the plurality of timers 65 has been activated for a time greater than, less than, or equal to one of the plurality of timer thresholds 60. The plurality of timer thresholds 60 may include a vehicle timer threshold 61; a compressor deactivation timer threshold 62; a compressor activation timer threshold 63; and an exit timer threshold 64.

The vehicle timer threshold 61 is associated with the vehicle timer 66 and is the length of time at which there is an increased statistical likelihood that the evaporator 22 will ice over if the vehicle timer 66 has been activated for a length of time less than the vehicle timer threshold 61.

The compressor deactivation timer threshold 62 is associated with the strategy timer 67 and is the length of time at which there is an increased statistical likelihood that the evaporator 22 will ice over if the strategy timer 67 has been activated for a length of time greater than or equal to the compressor deactivation timer threshold 62.

The compressor reactivation timer threshold 63 is associated with the compressor reactivation timer 68 and is the length of time at which there is an increased statistical likelihood that the evaporator 22 will ice over if the compressor reactivation timer 68 has been activated for a length of time less than the compressor reactivation timer threshold 63. Additionally, the compressor reactivation timer threshold 63 reflects the least amount of time the compressor 26 must be deactivated to prevent icing of the evaporator 22. As such, the compressor reactivation timer threshold 63 may be calibrated such that the compressor 26 will be deactivated for the least amount of time necessary to prevent and/or remedy icing of the evaporator 22.

The exit timer threshold 64 is associated with the exit timer 69 and is the length of time at which there is an increased statistical likelihood that the evaporator 22 will ice over if the exit timer 69 has been activated for a length of time less than the exit timer threshold 64.

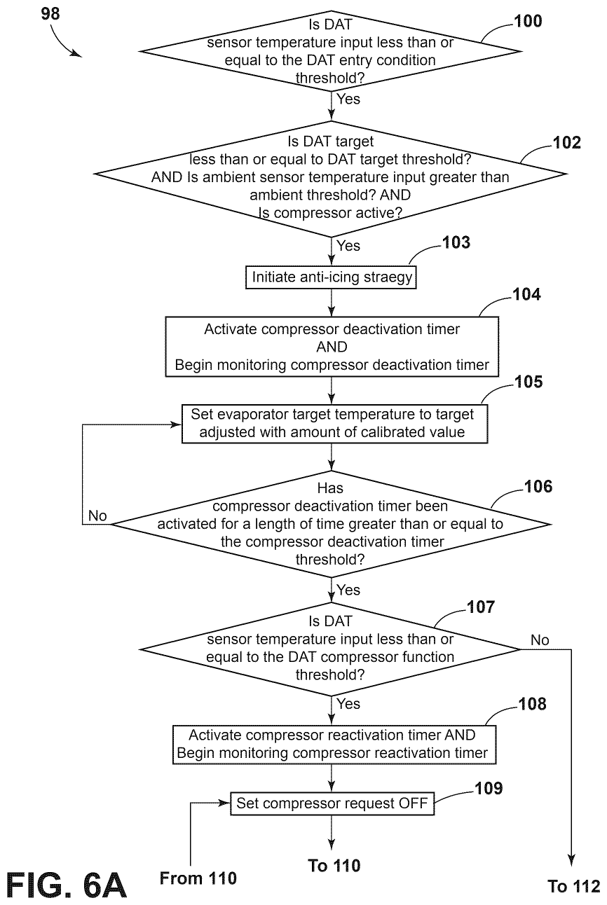

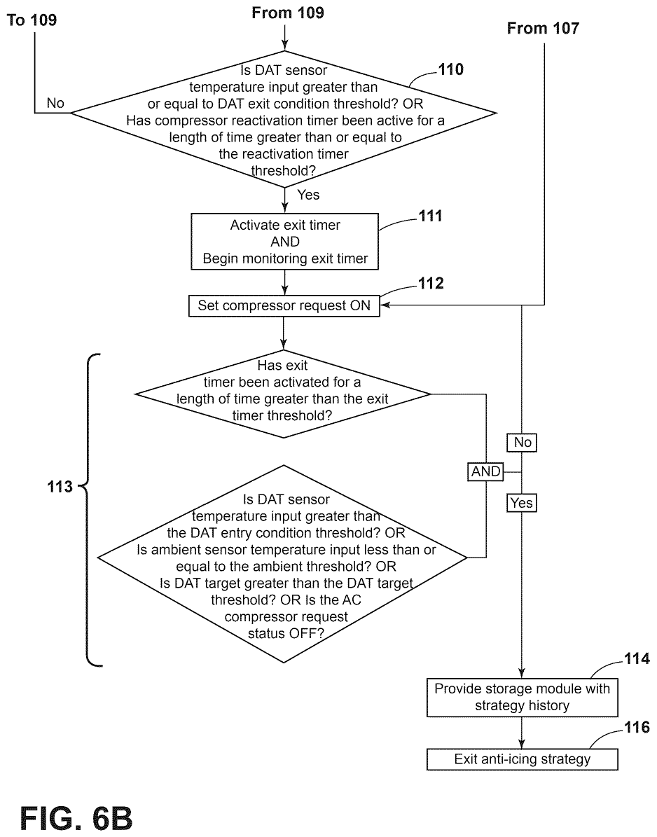

Referring now to FIG. 6A and FIG. 6B, a first embodiment of the anti-icing strategy 98 determined and executed by the processor 46 of the controller 40 is shown. At step 100, the processor 46 monitors the DAT sensor temperature input and compares the DAT sensor temperature input to the DAT entry condition threshold 51. If the processor 46 receives an input from the DAT temperature sensor 33 of a temperature less than or equal to the temperature provided by the DAT entry condition threshold 51, the processor 46 then proceeds to step 102 of the anti-icing strategy 98.

At step 102, the processor 46 determines whether the DAT target has been set to a temperature that is less than or equal to the DAT target threshold, whether the ambient air temperature sensor 31 provides an input of a temperature greater than the ambient threshold 54; and whether the compressor 26 is active. If the DAT target has been set to a temperature less than or equal to the DAT target threshold; the ambient air temperature sensor 31 has provided an input of a temperature greater than the ambient threshold 54; and the compressor 26 is active, the processor 46 will proceed to step 103.

At step 103, the processor 46 initiates the anti-icing strategy 98. The processor then proceeds to step 104.

At step 104, the processor activates the compressor deactivation timer 67 and begins monitoring the compressor deactivation timer 67. The processor then proceeds to step 105.

At step 105, the processor 46 adjusts the air conditioner 12 through increasing the target temperature of the evaporator 22 by the amount of the calibrated value 70 such that the evaporator 22 is warmed. The processor 46 then proceeds to step 106.

At step 106, the processor 46 determines the length of time the compressor deactivation timer 67 has been active and compares this length of time to the compressor deactivation timer threshold 62. If the length of time the compressor deactivation timer 67 has been activated for is greater than or equal to the compressor deactivation timer threshold 62, the processor 46 then proceeds to step 107 of the anti-icing strategy 98.

If at step 106, the processor determines that the length of time the compressor deactivation timer 67 has been activated is less than the compressor deactivation timer threshold 62, the processor will maintain the increased target temperature of the evaporator 22 with the calibrated value 70 until the compressor deactivation timer 67 has been active for a length of time greater than or equal to the compressor deactivation timer threshold 62.

At step 107 the processor 46 compares the DAT sensor temperature input to the DAT compressor function threshold 52. If the DAT sensor temperature input is less than or equal to the DAT compressor function threshold 52, the processor 46 then proceeds to step 108 of the anti-icing strategy 98.

If at step 107 the processor determines that the DAT sensor temperature input is greater than the DAT compressor function threshold 52, the processor 46 will proceed to step 112 of the anti-icing strategy 98.

At step 108, the processor 46 activates the compressor reactivation timer 68 and begins monitoring the compressor reactivation timer 68. The processor 46 then proceeds to step 109.

At step 109, the processor 46 further adjusts the air conditioner 12 through deactivating the compressor 26. Specifically, the processor 46 sets a compressor request to an OFF status. The processor 46 then proceeds to step 110 of the anti-icing strategy 98.

At step 110, the processor 46 compares the DAT sensor temperature input to the DAT exit condition threshold 53. If the DAT sensor temperature input is greater than or equal to the DAT exit condition threshold 53, the processor 46 then proceeds to step 111 of the anti-icing strategy 98. Additionally, at step 110, the processor 46 determines the length of time the compressor reactivation timer 68 has been active and compares this length of time to the compressor reactivation timer threshold 63. If the compressor reactivation timer 68 has been active for a length of time greater than or equal to the reactivation timer threshold 63, the processor 46 will proceed to step 111 of the anti-icing strategy 98.

If at step 110, the DAT sensor temperature input is less than the DAT exit condition threshold 53 and if the compressor reactivation timer 68 has not been active for a length of time greater than or equal to the compressor reactivation timer threshold 63, then the processor 46 will proceeds back to step 109 and maintain the compressor request in an OFF status.

At step 111, the processor 46 activates the exit timer 69 and begins monitoring the exit timer 69. The processor 46 then proceeds to step 112 of the anti-icing strategy 98.

At step 112, the processor 46 adjusts the compressor 26 through reactivating the compressor 26. Specifically, the processor 46 sets the compressor request to an ON status. The processor then proceeds to step 113 of the anti-icing strategy 98.

At step 113, the processor 46 determines the length of time the exit timer 69 has been activated and compares this length of time to the exit timer threshold 64. Additionally, at step 113, the processor 46 compares the DAT sensor temperature input to the DAT entry condition threshold 51. If the length of time the exit timer 69 has been activated is greater than the exit timer threshold 64 and the DAT sensor temperature input is greater than the DAT entry condition threshold 51, the processor 46 will proceed to step 114 of the anti-icing strategy.

Alternatively, at step 113, the processor 46 determines the length of time the exit timer 69 has been activated and compares this length of time to the exit timer threshold 64. Additionally, at step 113, the processor 46 compares the ambient air temperature sensor input to the ambient threshold 54. If the length of time the exit timer 69 has been activated is greater than the exit timer threshold 64 and the ambient air temperature sensor input is less than or equal to the ambient threshold 54, the processor 46 will proceed to step 114 of the anti-icing strategy.

In an additional alternative, at step 113, the processor 46 determines the length of time the exit timer 69 has been activated and compares this length of time to the exit timer threshold 64. Additionally, at step 113, the processor 46 compares the DAT target to the DAT target threshold. If the length of time the exit timer 69 has been activated is greater than the exit timer threshold 64 and the DAT target has been set to a temperature higher than the DAT target threshold, the processor 46 will proceed to step 114 of the anti-icing strategy.

In an additional alternative, at step 113, the processor 46 determines the length of time the exit timer 69 has been activated and compares this length of time to the exit timer threshold 64. Additionally, at step 113 the processor 46 checks the compressor status. If the length of time the exit timer 69 has been activated is greater than the exit timer threshold 64 and the compressor 26 has been deactivated by the user, the processor 46 will proceed to step 114 of the anti-icing strategy 98.

If at step 113, the processor 46 determines that the exit timer 69 has not been activated for a length of time greater than the exit timer threshold 64, or that neither the DAT sensor temperature input is greater than the DAT entry condition threshold 51; the ambient air sensor temperature input is less than the ambient threshold 54, the DAT target is greater than the DAT temperature threshold, nor that the AC compressor request status is OFF, then the processor 46 will not proceed to step 114 and will maintain the compressor request status as ON at step 112. The processor 46 will continue monitoring the exit timer 69 and each of the plurality of sensors 30 provided in step 113 until the prerequisites of step 113 are fulfilled.

At step 114, the processor 46 is configured to provide the storage module 44 of the controller with the strategy history 80, wherein the strategy history 80 represents that the processor 46 initiated the anti-icing strategy 98 at step 103. The storage module 44 is configured to store the strategy history 80 for at least one drive cycle of the vehicle 1, wherein the at least one drive cycle comprises a deactivation, activation, and then subsequent deactivation of the vehicle 1. The process 46 will then proceed to step 116 of the anti-icing strategy 98.

At step 116, the processor 46 exits the anti-icing strategy 98. Specifically, the processor 46 will stop adjusting the evaporator target temperature with the amount of the calibrated value 70.

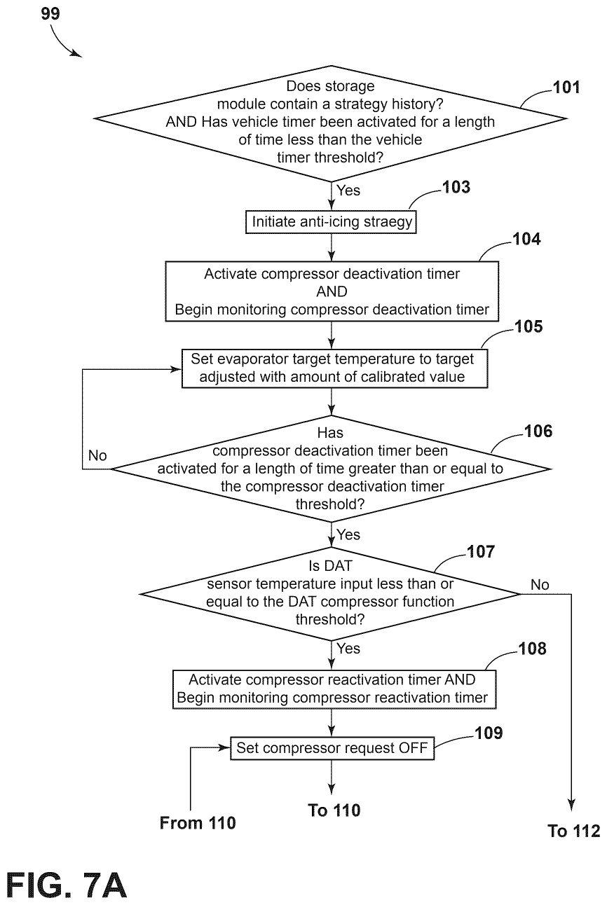

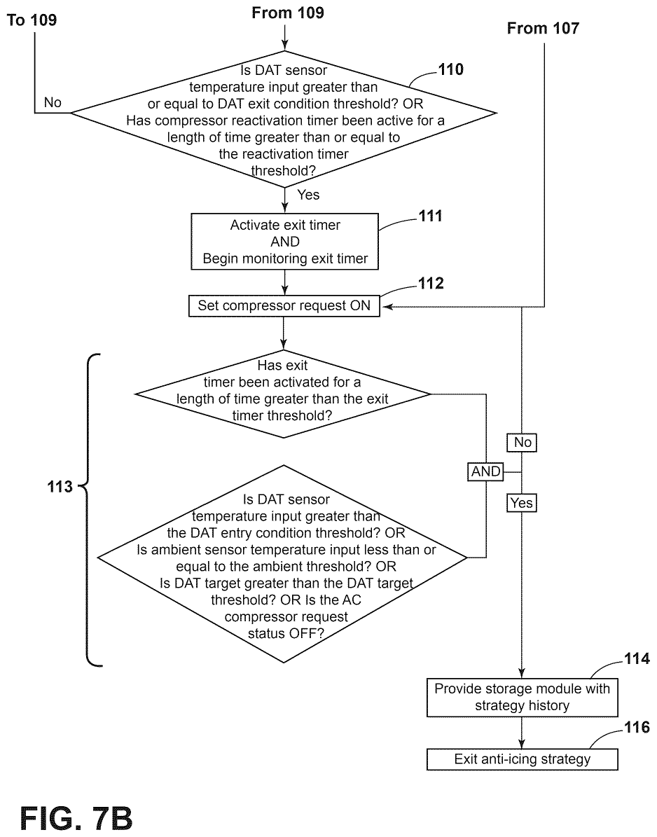

Referring now to FIGS. 7A and 7B, a second embodiment of the anti-icing strategy 99 determined and executed by the processor 46 of the controller 40 is shown. At step 101, the vehicle 1 is activated, and the processor 46 checks the storage module 44 to determine whether the storage module 44 contains a strategy history 80 provided by the processor 46 at the conclusion of an anti-icing strategy 98,99 that occurred in a previous drive cycle. Additionally, the processor 46 determines the length of time the vehicle timer 66 had been activated for, wherein the vehicle timer 66 was activated by the processor 46 when the vehicle 1 was last deactivated. If the storage module 44 contains the strategy history 80 and the vehicle timer 66 has been active for a length of time less than the vehicle timer threshold 61, the processor 46 will proceed to step 103.

At step 103, the processor 46 initiates the anti-icing strategy 98. The processor then proceeds to step 104.

At step 104, the processor activates the compressor deactivation timer 67 and begins monitoring the compressor deactivation timer 67. The processor then proceeds to step 105.

At step 105, the processor 46 adjusts the air conditioner 12 through increasing the target temperature of the evaporator 22 by the amount of the calibrated value 70 such that the evaporator 22 is warmed. The processor 46 then proceeds to step 106.

At step 106, the processor 46 determines the length of time the compressor deactivation timer 67 has been active and compares this length of time to the compressor deactivation timer threshold 62. If the length of time the compressor deactivation timer 67 has been activated for is greater than or equal to the compressor deactivation timer threshold 62, the processor 46 then proceeds to step 107 of the anti-icing strategy 98.

If at step 106, the processor determines that the length of time the compressor deactivation timer 67 has been activated is less than the compressor deactivation timer threshold 62, the processor will maintain the increased target temperature of the evaporator 22 with the calibrated value 70 at step 105 until the compressor deactivation timer 67 has been active for a length of time greater than or equal to the compressor deactivation timer threshold 62.

At step 107 the processor 46 compares the DAT sensor temperature input to the DAT compressor function threshold 52. If the DAT sensor temperature input is less than or equal to the DAT compressor function threshold 52, the processor 46 then proceeds to step 108 of the anti-icing strategy 98.

If at step 107 the processor determines that the DAT sensor temperature input is greater than the DAT compressor function threshold 52, the processor 46 will proceed to step 112 of the anti-icing strategy 98.

At step 108, the processor 46 activates the compressor reactivation timer 68 and begins monitoring the compressor reactivation timer 68. The processor 46 then proceeds to step 109.

At step 109, the processor 46 further adjusts the air conditioner 12 through deactivating the compressor 26. Specifically, the processor 46 sets a compressor request to an OFF status. The processor 46 then proceeds to step 110 of the anti-icing strategy 98.

At step 110, the processor 46 compares the DAT sensor temperature input to the DAT exit condition threshold 53. If the DAT sensor temperature input is greater than or equal to the DAT exit condition threshold 53, the processor 46 then proceeds to step 111 of the anti-icing strategy 98. Additionally, at step 110, the processor 46 determines the length of time the compressor reactivation timer 68 has been active and compares this length of time to the compressor reactivation timer threshold 63. If the compressor reactivation timer 68 has been active for a length of time greater than or equal to the reactivation timer threshold 63, the processor 46 will proceed to step 111 of the anti-icing strategy 98.

If at step 110, the DAT sensor temperature input is less than the DAT exit condition threshold 53 and if the compressor reactivation timer 68 has not been active for a length of time greater than or equal to the compressor reactivation timer threshold 63, then the processor 46 will proceeds back to step 109 and maintain the compressor request in an OFF status.

At step 111, the processor 46 activates the exit timer 69 and begins monitoring the exit timer 69. The processor 46 then proceeds to step 112 of the anti-icing strategy 98.

At step 112, the processor 46 adjusts the compressor 26 through reactivating the compressor 26. Specifically, the processor 46 sets the compressor request to an ON status. The processor then proceeds to step 113 of the anti-icing strategy 98.

At step 113, the processor 46 determines the length of time the exit timer 69 has been activated and compares this length of time to the exit timer threshold 64. Additionally, at step 113, the processor 46 compares the DAT sensor temperature input to the DAT entry condition threshold 51. If the length of time the exit timer 69 has been activated is greater than the exit timer threshold 64 and the DAT sensor temperature input is greater than the DAT entry condition threshold 51, the processor 46 will proceed to step 114 of the anti-icing strategy.

Alternatively, at step 113, the processor 46 determines the length of time the exit timer 69 has been activated and compares this length of time to the exit timer threshold 64. Additionally, at step 113, the processor 46 compares the ambient air temperature sensor input to the ambient threshold 54. If the length of time the exit timer 69 has been activated is greater than the exit timer threshold 64 and the ambient air temperature sensor input is less than or equal to the ambient threshold 54, the processor 46 will proceed to step 114 of the anti-icing strategy.

In an additional alternative, at step 113, the processor 46 determines the length of time the exit timer 69 has been activated and compares this length of time to the exit timer threshold 64. Additionally, at step 113, the processor 46 compares the DAT target to the DAT target threshold. If the length of time the exit timer 69 has been activated is greater than the exit timer threshold 64 and the DAT target has been set to a temperature higher than the DAT target threshold, the processor 46 will proceed to step 114 of the anti-icing strategy.

In an additional alternative, at step 113, the processor 46 determines the length of time the exit timer 69 has been activated and compares this length of time to the exit timer threshold 64. Additionally, at step 113 the processor 46 checks the compressor status. If the length of time the exit timer 69 has been activated is greater than the exit timer threshold 64 and the compressor 26 has been deactivated by the user, the processor 46 will proceed to step 114 of the anti-icing strategy 98.

If at step 113, the processor 46 determines that the exit timer 69 has not been activated for a length of time greater than the exit timer threshold 64, or that neither the DAT sensor temperature input is greater than the DAT entry condition threshold 51; the ambient air sensor temperature input is less than the ambient threshold 54, the DAT target is greater than the DAT temperature threshold, nor that the AC compressor request status is OFF, then the processor 46 will not proceed to step 114 and will maintain the compressor request status as ON at step 112. The processor 46 will continue monitoring the exit timer 69 and each of the plurality of sensors 30 provided in step 113 until the prerequisites of step 113 are fulfilled.

At step 114, the processor 46 is configured to provide the storage module 44 of the controller with the strategy history 80, wherein the strategy history 80 represents that the processor 46 initiated the anti-icing strategy 98 at step 103. The storage module 44 is configured to store the strategy history 80 for at least one drive cycle of the vehicle 1, wherein the at least one drive cycle comprises a deactivation, activation, and then subsequent deactivation of the vehicle 1. The processor 46 will then proceed to step 116 of the anti-icing strategy 98.

At step 116, the processor 46 exits the anti-icing strategy 98. Specifically, the processor 46 will stop adjusting the evaporator target temperature with the amount of the calibrated value 70.

The vehicle climate control system 10 advantageously executes an anti-icing strategy to predict and prevent icing of an evaporator 22 of an air conditioner 12 in a motor vehicle to thereby enhance the performance of the air conditioner 12.

In an additional embodiment, the anti-icing strategy 98 may be utilized in a vehicle climate control system 10 that includes a heat pump. Specifically, the anti-icing strategy 98 may be utilized when the heat pump of the vehicle climate control system 10 is set in a cooling mode to provide cooled air to the interior of the vehicle 2. In such a configuration, the anti-icing strategy 98 will be employed to prevent the formation of ice on an internal heat exchanger that is functioning as an evaporator 22.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A climate control system for a vehicle, the climate control system comprising:
a compressor;
an evaporator;
a plurality of sensors; and
a controller, in communication with the plurality of sensors and comprising at least one timer, the controller configured to execute an anti-icing strategy comprising the steps of:
monitoring the plurality of sensors;
determining a likelihood of ice formation on the evaporator;
adjusting the climate control system based on the determined likelihood of ice formation;
activating one or more of the at least one timer in response to the adjustment of the climate control system; and
monitoring the at least one timer and controlling the climate control system based on the at least one timer.

2. The climate control system for a vehicle of claim 1, wherein at least one of the plurality of sensors comprises a duct air temperature sensor.

3. The climate control system for a vehicle of claim 1, wherein at least one of the plurality of sensors includes an ambient air temperature sensor.

4. The climate control system for a vehicle of claim 1, wherein the controller determines the likelihood of ice formation on the evaporator by comparing a duct discharge air temperature target to a duct discharge air temperature target threshold.

5. The climate control system for a vehicle of claim 1, wherein the controller determines the likelihood of ice formation on the evaporator by comparing inputs provided to the controller by the plurality of sensors to a plurality of calibrated thresholds.

6. The climate control system for a vehicle of claim 1, wherein the controller determines the likelihood of ice formation on the evaporator by comparing the time the at least one timer has been activated for to a plurality of timer thresholds.

7. The climate control system for a vehicle of claim 1, wherein the controller adjusts the climate control system based on the determined likelihood of ice formation by adjusting an evaporator target temperature with a calibrated value.

8. The climate control system for a vehicle of claim 7, wherein the controller determines that there is a likelihood of ice formation when each of the plurality of sensors detects an input that reaches a calibrated threshold.

9. The climate control system for a vehicle of claim 1, wherein the controller adjusts the climate control system based on the determined likelihood of ice formation by deactivating the compressor.

10. The climate control system for a vehicle of claim 9, wherein the controller determines that there is a likelihood of ice formation when one or more of the plurality of sensors detect an input that reaches a calibrated threshold and when the at least one timer has been activated for a time exceeding a timer threshold.

11. The climate control system for a vehicle of claim 1, wherein the controller adjusts the climate control system based on the determined likelihood of ice formation by reactivating the compressor, wherein the controller determines that there is not a likelihood of ice formation when one or more of the plurality of sensors detects an input that reaches the calibrated threshold, wherein the calibrated threshold is a duct air temperature exit condition threshold.

12. The climate control system for a vehicle of claim 11, wherein the controller adjusts the climate control system based on the determined likelihood of ice formation by reactivating the compressor, wherein the controller determines that there is not a likelihood of ice formation when the at least one timer has been activated for a time equal to or exceeding the timer threshold, wherein the timer threshold is a compressor reactivation timer threshold.

13. The climate control system for a vehicle of claim 1, wherein the controller determines that there is a likelihood of ice formation when each of the plurality of sensors detects an input that reaches a calibrated threshold and the compressor has an active status.

14. A method for controlling a vehicle climate control system, the method comprising the steps of:
activating a compressor of the vehicle climate control system;
sensing ambient air temperature with a first temperature sensor;
sensing air duct temperature with a second temperature sensor;
monitoring, with a controller, the sensed ambient air temperature and the duct air temperature;
determining the likelihood of ice formation on the evaporator;
adjusting, with the controller, the vehicle climate control system based on the determined likelihood of ice formation;
activating at least one timer in response to the adjusting of the vehicle climate control system with the controller; and
controlling the vehicle climate control system based, at least in part on the at least one timer.

15. The method for controlling a vehicle climate control system of claim 14 wherein the second temperature sensor comprises a duct air temperature sensor.

16. The climate control system for a vehicle of claim 14, wherein the controller determines the likelihood of ice formation on the evaporator by comparing a duct discharge air temperature target to a duct discharge air temperature target threshold.

17. The method for controlling a vehicle climate control system of claim 14, wherein the controller determines the likelihood of ice formation on the evaporator by comparing inputs provided to the controller by the plurality of sensors to a plurality of calibrated thresholds.

18. The method for controlling a vehicle climate control system of claim 14, wherein the controller adjusts the climate control system based on the determined likelihood of ice formation by adjusting an evaporator target of an evaporator with a calibrated value.

19. The method for controlling a vehicle climate control system of claim 14, wherein the controller adjusts the vehicle climate control system based on the determined likelihood of ice formation by deactivating the compressor, wherein the controller determines that there is a likelihood of ice formation when one or more of the plurality of sensors detect an input that reaches a calibrated threshold and when the at least one timer has been activated for a time exceeding a timer threshold.

20. The method for controlling a vehicle climate control system of claim 19, wherein the controller adjusts the vehicle climate control system based on the determined likelihood of ice formation by reactivating the compressor, wherein the controller determines that there is not a likelihood of ice formation when the second sensor detects an input that is greater than a calibrated threshold, wherein the calibrated threshold is a duct air temperature exit condition threshold.
